(19) United States
(12) Patent Application Publication
(10) Pub. No.: US 2024/0147004 A1
(43) Pub. Date: May 2, 2024

(54) TERMINAL DEVICE, INFORMATION PROCESSING METHOD, AND NON-TRANSITORY RECORDING MEDIUM

(71) Applicant: Seiichi KONDO, Tokyo (JP)

(72) Inventor: Seiichi KONDO, Tokyo (JP)

(21) Appl. No.: 18/379,672

(22) Filed: Oct. 13, 2023

(30) Foreign Application Priority Data
Oct. 26, 2022 (JP) 2022-171834
Sep. 4, 2023 (JP) 2023-143111

(51) Int. Cl. H04N 21/45; G06F 8/30; G06F 21/62

(52) U.S. Cl. CPC H04N 21/4532; G06F 8/31; G06F 21/629

(57) ABSTRACT

A terminal device, an information processing method, and a non-transitory recording medium. The terminal device verifies whether a browser of the terminal device is capable of performing predetermined image processing using verification information on a photographic subject based on a capturing operation on the photographic subject, based on determination that the browser is capable of performing the predetermined image processing, acquires a first image processing library written in a first programming language to perform the predetermined image processing and display a result of the predetermined image processing performed on a screen of the terminal device, and based on determination that the browser is incapable of performing the predetermined image processing, acquires a second image processing library written in a second programming language to perform the predetermined image, and display a result of the predetermined image processing performed on the screen of the terminal device.

### CROSS-REFERENCE TO RELATED APPLICATIONS

This patent application is based on and claims priority pursuant to 35 U.S.C. § 119(a) to Japanese Patent Applications No. 2022-171834, filed on Oct. 26, 2022, and No. 2023-143111, filed on Sep. 4, 2023, in the Japan Patent Office, the entire disclosure of which is hereby incorporated by reference herein.

### BACKGROUND

### Technical Field

The present disclosure relates to a terminal device, an information processing method, and a non-transitory recording medium.

### Background Art

Techniques have been developed for uploading a document scanned by an image forming apparatus and for printing a document stored in a cloud storage each in cooperation with cloud services such as GOOGLE (registered trademark) and OFFICE365 (registered trademark) provided by outside vendors. By combining these techniques with functions such as optical character recognition (OCR), image cropping, and barcode authentication, a platform has been developed that allows creation of an application with a high degree of freedom and functionality.

Such application is called a workflow application, and is executable from a web browser of a mobile terminal (an example of a terminal device) in addition to executing on an operation terminal of an image forming apparatus.

### SUMMARY

Embodiments of the present disclosure describe a terminal device, an information processing method, and a non-transitory recording medium.

According to one embodiment, the terminal device verifies whether a browser of the terminal device is capable of performing predetermined image processing, using verification information on a photographic subject based on a capturing operation on the photographic subject, based on a determination that the browser is capable of performing the predetermined image processing as a result of the verification, acquires a first image processing library written in a first programming language to perform the predetermined image processing using the first image processing library, and displays a result of the predetermined image processing performed based on the first image processing library on a screen of the terminal device, and based on a determination that the browser is incapable of performing the predetermined image processing as a result of the verification, acquires a second image processing library written in a second programming language to perform the predetermined image processing using the second image processing library, and displays a result of the predetermined image processing performed based on the second image processing library on the screen of the terminal device.

According to one embodiment, an information processing method executed by a terminal device to perform predetermined image processing through a browser includes verifying whether a browser of the terminal device is capable of performing the predetermined image processing using verification information on a photographic subject based on a capturing operation on the photographic subject, based on a determination that the browser is capable of performing the predetermined image processing as a result of the verification, the method further includes acquiring a first image processing library written in a first programming language to perform the predetermined image processing, performing the predetermined image processing using the first image processing library, and displaying a result of the predetermined image processing performed based on the first image processing library on a screen of the terminal device, and based on a determination that the browser is incapable of performing the predetermined image processing as a result of the verification, the method further includes acquiring a second image processing library written in a second programming language to perform the predetermined image processing, performing the predetermined image processing using the second image processing library, and displaying a result of the predetermined image processing performed based on the second image processing library on the screen of the terminal device.

According to one embodiment, a non-transitory recording medium storing a plurality of instructions which, when executed by one or more processors on a terminal device, causes the processors to perform an information processing method including, verifying whether a browser of the terminal device is capable of performing the predetermined image processing using verification information on a photographic subject based on a capturing operation on the photographic subject, based on a determination that the browser is capable of performing the predetermined image processing as a result of the verification, the method further includes acquiring a first image processing library written in a first programming language to perform the predetermined image processing, performing the predetermined image processing using the first image processing library, and displaying a result of the predetermined image processing performed based on the first image processing library, and based on a determination that the browser is incapable of performing the predetermined image processing as a result of the verification, the method further includes acquiring a second image processing library written in a second programming language to perform the predetermined image processing, performing the predetermined image processing using the second image processing library, and displaying a result of the predetermined image processing performed based on the second image processing library on the screen of the terminal device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of a configuration of an information processing system according to embodiments of the present disclosure;

FIG. 2 is a block diagram illustrating an example of a hardware configuration of a terminal device included in the information processing system according to embodiments of the present disclosure:

FIG. 3 is a block diagram illustrating an example of a hardware configuration of a server included in the information processing system according to embodiments of the present disclosure;

FIGS. 4A and 4B are a diagram illustrating an example of a display sequence of a user interface (UI) screen in the terminal device included in the information processing system according to embodiments of the present disclosure:

FIGS. 5A and 5B are a sequence diagram illustrating an example of a predetermined image processing executed by the information processing system according to embodiments of the present disclosure; and

FIGS. 6A and 6B are a sequence diagram illustrating another example of the predetermined image processing executed by the information processing system according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Exemplary embodiments of a terminal device, an information processing method, a program, and an information processing system are described below in detail with reference to the accompanying drawings.

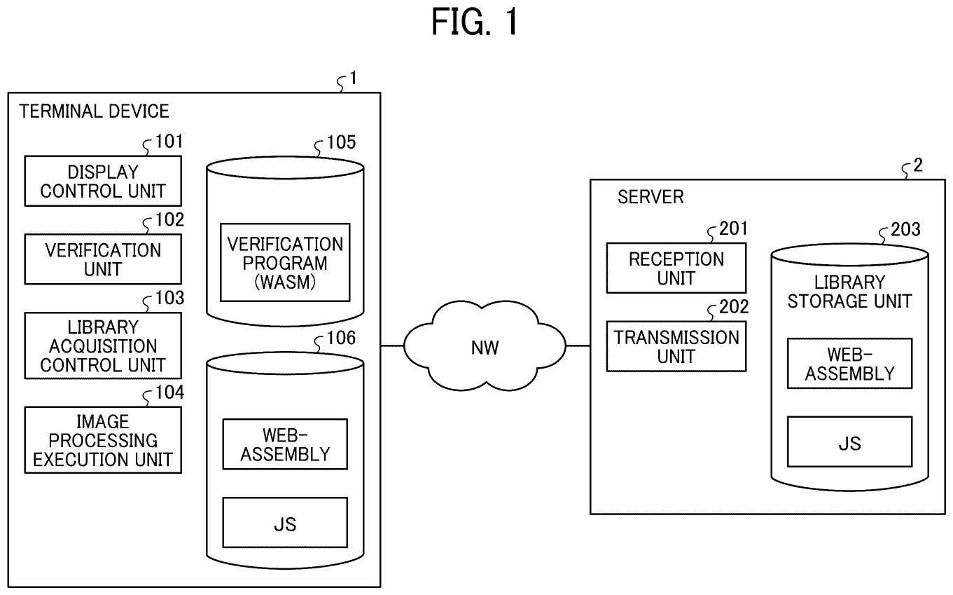

FIG. 1 is a block diagram illustrating an example of a configuration of an information processing system according to embodiments of the present disclosure. The information processing system according to the present embodiment includes a terminal device 1 and a server 2 as illustrated in FIG. 1. The terminal device 1 and the server 2 are connected through a network NW such as the internet.

The server 2 includes a reception unit 201, a transmission unit 202, and a library storage unit 203, as illustrated in FIG. 1. The library storage unit 203 stores an image processing library, which includes predetermined image processing programs. Specifically, the library storage unit 203 stores a first image processing library and a second image processing library.

The predetermined image processing (an example of the predetermined processing) is performed through the terminal device 1, is a preset processing, and includes, for example, trapezoidal correction. The trapezoidal correction is image processing for storing a photographic subject captured by a camera of the terminal device 1 within a rectangle displayed on a screen of the terminal device 1 expressed by a predetermined frame line. Although image processing is described below as an example of the predetermined processing, the predetermined processing is not limited to the image processing. For example, the predetermined processing may be a process of converting, transforming, analyzing, or extracting information on any data such as image data, video data, text data, and music data.

Furthermore, the first image processing library is an image processing library written in a first programming language that executes the predetermined image processing. Also, the first image processing library is a library written in the same program language (an example of a first program language) as that of verification information for the terminal device 1, more specifically, a web browser of the terminal device 1, to verify whether the predetermined image processing is executable on the photographic subject. Also, the first image processing library may be a library executed by the web browser (an example of a browser). In the present embodiment, the programming language for writing the first image processing library may be WebAssembly (WASM). In the following, verifying whether software including the web browser included in the terminal device 1 is able to execute the predetermined process, may be expressed as verifying whether the predetermined process is executable by the terminal device 1.

Further, the second image processing library is an image processing library written in a second programming language that executes the predetermined image processing. Further, the second image processing library is a library written in a programming language (an example of a second programming language) different from that of the verification information. The second image processing library may be a library executed by the web browser (an example of the browser). In the present embodiment, the programming language for writing the second image processing library may be JAVA SCRIPT (registered trademark, hereinafter referred to as JS). The image processing using the first image processing library sometimes reduces processing time compared to the image processing using the second image processing library.

In a case where the web browser is capable of executing image processing using the first image processing library, using of the first image processing library is preferable compared to using the second image processing library.

The reception unit 201 receives a result of predetermined image processing on the photographic subject (that is, the image on which the predetermined image processing has been performed in the terminal device 1) from the terminal device 1. The transmission unit 202 transmits the first image processing library or the second image processing library to the terminal device 1. The server 2 may include a functional unit that executes a workflow including desired processing on the result of predetermined image processing on the photographic subject received by the reception unit 201. Examples of the workflow may include processing for storing the result of predetermined image processing on the photographic subject in a storage area in the server 2, and processing for transmitting the results of predetermined image processing on the photographic subject to a desired destination such as an external server, email address, or fax number. The server 2 may determine the destination by analyzing the result of the predetermined image processing on the photographic subject. The server 2 may implement part or all of the workflow processing by cooperating with an external server.

The terminal device 1 includes a display control unit 101, a verification unit 102, a library acquisition control unit 103, an image processing execution unit 104, a verification program storage unit 105, and an image processing library storage unit 106, as illustrated in FIG. 1. One or more functional units among the display control unit 101, the verification unit 102, the library acquisition control unit 103, the image processing execution unit 104, the verification program storage unit 105, and the image processing library storage unit 106 may be implemented by the web browser. For example, part or all of the functions implemented by one or more functional units may be implemented by a program running on the web browser. In a case where the terminal device 1 includes a plurality of web browsers, one or more functional units may be implemented by each web browser.

The verification program storage unit 105 stores verification information. The verification information is information for verifying whether the terminal device 1 is capable of performing the predetermined image processing on the photographic subject (for example, an image photographed by the terminal device 1). In the present embodiment, the verification information may be a simple program written in WASM, which is an example of a programming language for writing the first image processing library. The image processing library storage unit 106 stores the first image processing library and the second image processing library acquired from the server 2.

The verification unit 102 is an example of a verification unit that executes verification processing to determine whether the terminal device 1 (web browser) is capable of performing the predetermined image processing based on a capturing operation of the photographic subject using the verification information. In the present embodiment, the verification unit 102 determines that predetermined image processing is executable in the terminal device 1 (web browser) based on a verification result that a program written in WASM, which is an example of verification information, is executable.

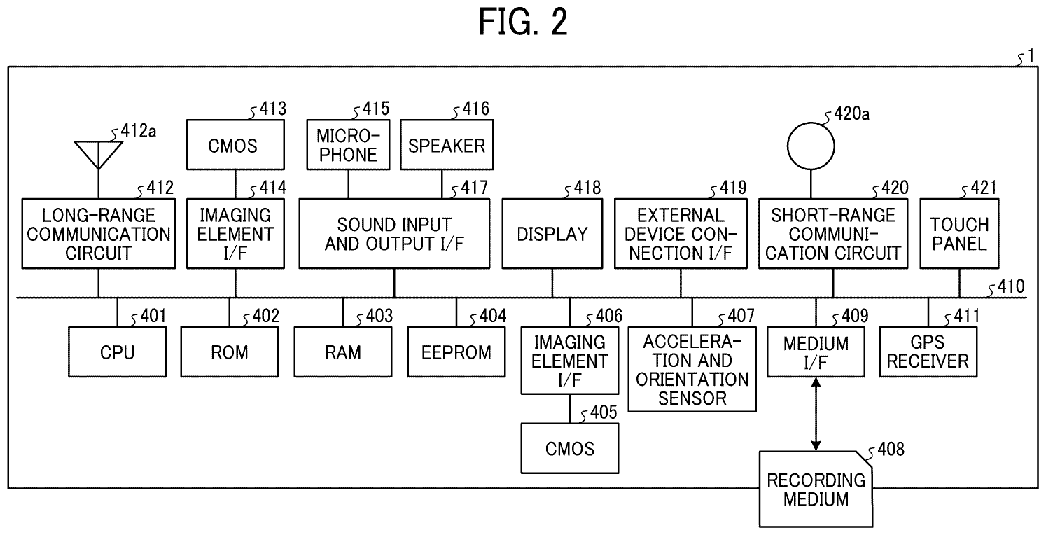

On the other hand, in a case where a program written in WASM, which is an example of verification information is not executable, the verification unit 102 determines that predetermined image processing is not executable in the terminal device 1 (web browser). Further, the verification unit 102 executes verification processing when the use of a complementary metal oxide semiconductor (CMOS) sensor 405 (see FIG. 2), which is an example of a camera or an imaging device that performs capturing of the photographic subject, is permitted during a capturing operation.

The library acquisition control unit 103 is an example of an acquisition control unit that acquires the first image processing library for executing the predetermined image processing based on determination by the verification unit 102 that the terminal device 1 is capable of executing the predetermined image processing. On the other hand, based on determination that the terminal device 1 is not capable of executing the predetermined image processing, the library acquisition control unit 103 acquires the second image processing library for executing the predetermined image processing. In the present embodiment, the library acquisition control unit 103 acquires the first image processing library and the second image processing library each from the server 2. Then, the library acquisition control unit 103 stores the acquired first image processing library and second image processing library in the image processing library storage unit 106. The library acquisition control unit 103 also functions as an example of a transmission unit that transmits to the server 2 the result of the predetermined image processing performed on the photographic subject by the image processing execution unit 104, which is described below.

The image processing execution unit 104 is an example of an image processing unit that executes the predetermined image processing using the first image processing library or the second image processing library. That is, when the library acquisition control unit 103 acquires the first image processing library, the library acquisition control unit 103 executes the predetermined image processing using the first image processing library, and when the library acquisition control unit 103 acquires the second image processing library, the predetermined image processing is executed using the second image processing library. As a result, the image processing library that is executable on the web browser is able to execute the predetermined image processing on the image of the photographic subject, and the data processing function is implemented by the browser-based application.

The predetermined image processing includes the trapezoidal correction, binarization processing for converting an image into two colors, conversion processing to gray scale, and the like. The trapezoidal correction is a correction on the photographic subject such that the photographic subject captured by the CMOS sensor 405 (see FIG. 2) of the terminal device 1 fits into a rectangle represented by a predetermined frame line displayed on the screen of the terminal device 1. In other words, the trapezoidal correction is processing for correcting distortion of the photographic subject into a square.

The display control unit 101 is an example of a display control unit that displays on a display 418 (see FIG. 2), which is an example of a display unit (or screen) of the terminal device 1, the result of the predetermined image processing performed based on the first image processing library or the second image processing library. For example, the display control unit 101 causes the display 418 of the terminal device 1 to display the photographic subject on which predetermined image processing has been performed based on the first image processing library or the second image processing library.

Further, the display control unit 101 displays a screen including an operation item for receiving an editing operation (for example, correction of a boundary of the photographic subject included in an image) for the result of the predetermined image processing from the operator of the terminal device 1 on the display 418 of the terminal device 1. In response to receiving the operation of the operation item, the display control unit 101 displays the editing operation screen on the same screen as the screen displaying the result of the predetermined image processing or on a separate screen.

FIG. 2 is a block diagram illustrating an example of a hardware configuration of a terminal device included in the information processing system according to embodiments of the present disclosure. As illustrated in FIG. 2, the terminal device 1 such as a smartphone includes a central processing unit (CPU) 401, a read only memory (ROM) 402, a random access memory (RAM) 403, an electrically erasable and programmable ROM (EEPROM) 404, a CMOS sensor 405, an imaging element interface (I/F) 406, an acceleration and orientation sensor 407, a medium I/F 409 and a Global Positioning System (GPS) receiver 411.

The CPU 401 controls the operation of the entire communication terminal 1. The ROM 402 stores a control program such as an initial program loader (IPL) to boot the CPU 401.

The RAM 403 is used as a work area for the CPU 401. The EEPROM 404 reads or writes various data such as smartphone programs under the control of the CPU 401. The CMOS sensor 405 is an example of a built-in imaging device configured to capture an object (mainly, a self-image of a user) under the control of the CPU 401 to obtain image data. In alternative to the CMOS sensor, an imaging element such as a charge-coupled device (CCD) sensor may be used.

The imaging element I/F 406 is a circuit for controlling a drive of the CMOS sensor 405. The acceleration and orientation sensor 407 is one or more of various sensors such as an electronic magnetic compass and a gyrocompass for detecting geomagnetism, an acceleration sensor, and the like. The medium I/F 409 controls reading or writing (storing) of data with respect to a recording medium 408 such as a flash memory. The GPS receiver 411 receives a GPS signal from a GPS satellite.

In addition, the communication terminal 1 includes a long-range communication circuit 412, a CMOS sensor 413, an imaging element I/F 414, a microphone 415, a speaker 416, a sound input and output I/F 417, a display 418, an external device connection I/F 419, a short-range communication circuit 420, an antenna 420a of the short-range communication circuit 420, and a touch panel 421.

The long-range communication circuit 412 is a circuit that enables communication with other devices through the network NW. The CMOS sensor 413 is an example of a built-in imaging device configured to capture a subject under control of the CPU 401 to obtain image data. The imaging element I/F 414 is a circuit that controls the drive of the CMOS sensor 413. The microphone 415 is a built-in circuit that converts a sound into an electric signal. The speaker 416 is a built-in circuit that converts electrical signals into physical vibrations to produce sounds such as music and voice. The audio input and output I/F 417 is a circuit for inputting or outputting an audio signal between the microphone 415 and the speaker 416 under control of the CPU 401. The display 418 is an example of display device such as a liquid crystal display or an organic electro luminescence (EL) for displaying an image of a subject, various icons, and the like. The external device connection I/F 419 is an interface for connecting various external devices. The short-range communication circuit 420 is a communication circuit such as Near Field Communication (NFC) and BLUETOOTH (registered trademark). The touch panel 421 is an example of an input device that allows the user to operate the terminal device 1 by touching a screen of the display 418.

The terminal device 1 further includes a bus line 410. The bus line 410 is an address bus, a data bus, and the like for electrically connecting each component such as the CPU 401 illustrated in FIG. 2.

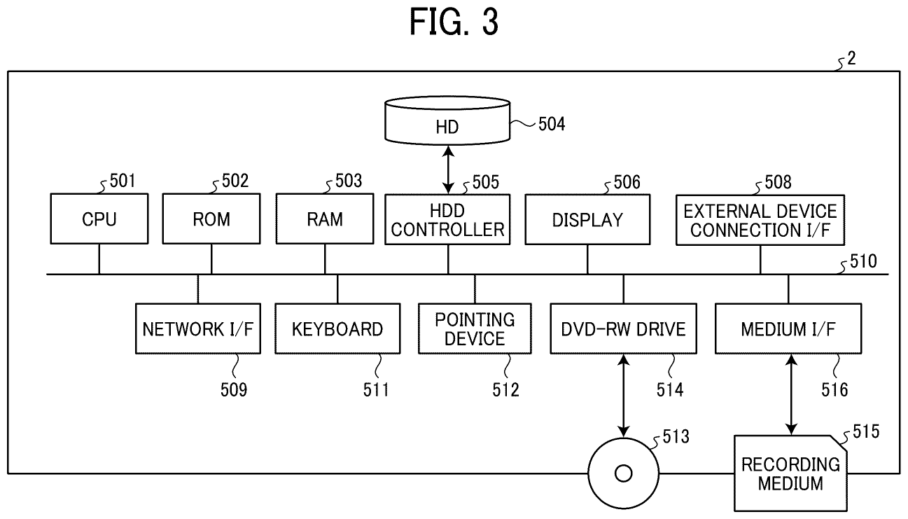

FIG. 3 is a block diagram illustrating an example of a hardware configuration of the server 2 included in the information processing system according to embodiments of the present disclosure. As illustrated in FIG. 3, the server 2 is implemented by a computer and includes a CPU 501, a ROM 502, a RAM 503, a hard disk (HD) 504, a hard disk drive (HDD) controller 505, a display 506, an external device connection I/F 508, a network I/F 509, a bus line 510, a keyboard 511, a pointing device 512, a Digital Versatile Disc-Rewritable (DVD-RW) drive 514, and a medium I/F 516.

The CPU 501 controls overall operation of the server 2. The ROM 502 stores a control program such as an initial program loader (IPL) to boot the CPU 501. The RAM 503 is used as a work area for the CPU 501. The HD 504 stores various data such as programs. The HDD controller 505 controls reading or writing of various data with respect to the HD 504 under the control of the CPU 501. The display 506 displays various information such as a cursor, menu, window, characters, or image. The external device connection I/F 508 is an interface for connecting various external devices. The external device in this case is, for example, a Universal Serial Bus (USB) memory or a printer. The network I/F 509 is an interface for performing data communication using the network NW. The bus line 510 is an address bus, a data bus, or the like for electrically connecting each component such as the CPU 501 illustrated in FIG. 3.

The keyboard 511 is an example of the input device provided with a plurality of keys for enabling a user to input characters, numerals, and various instructions. The pointing device 512 is an example of the input device for selecting and executing various instructions, selecting a processing target, moving a cursor, and the like. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading or writing (storing) of data with respect to a recording medium 515 such as a flash memory.

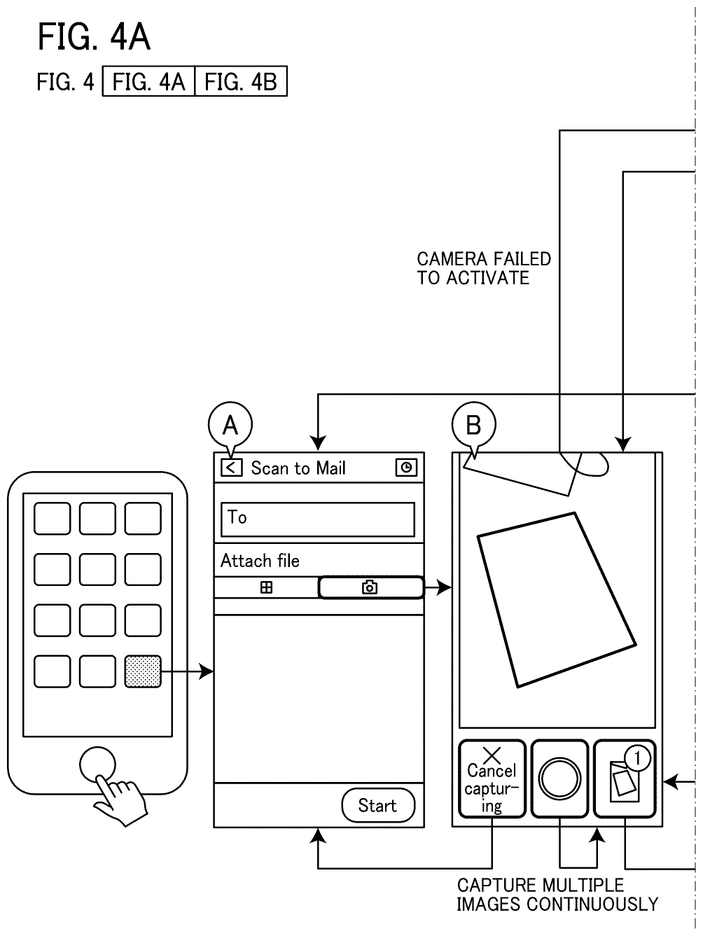

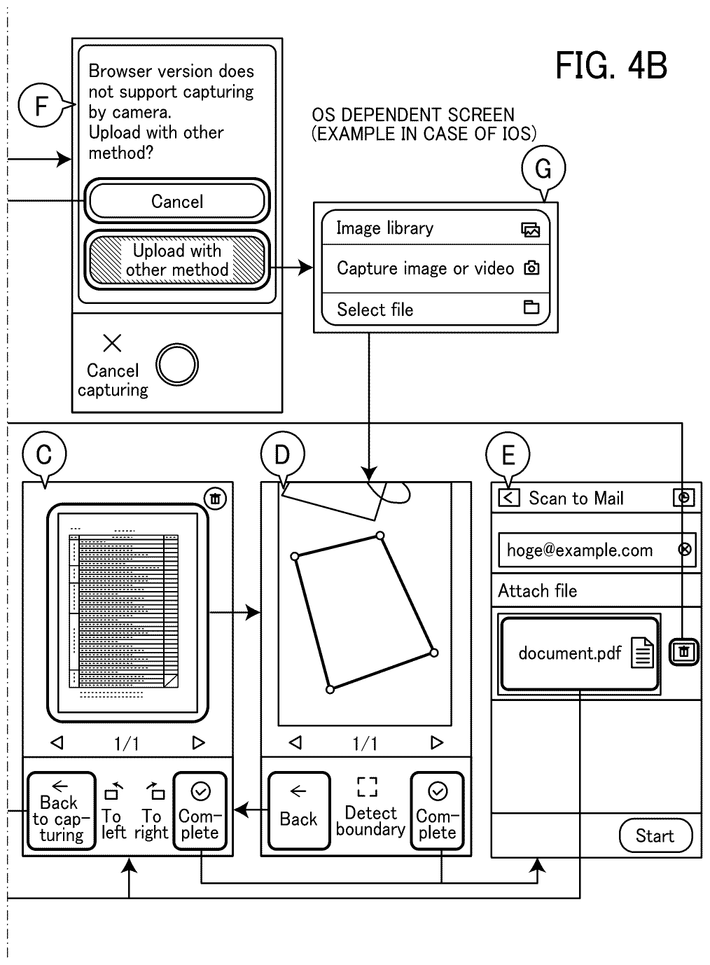

FIGS. 4A and 4B are a diagram illustrating an example of display sequence of a user interface (UI) screen displayed by the terminal device included in the information processing system according to embodiments of the present disclosure. In response to an instruction by a user to start an application that operates on the web browser of the terminal device 1, the display control unit 101 displays an application screen A that receives various operations on a display unit such as the display 418.

In response to a capturing operation on the application screen A performed by the user, the display control unit 101 displays a document capturing screen B on the display 418 in which the user instructs capturing of the photographic subject. The user is allowed to instruct capturing of a plurality of photographic subjects in succession on the document capturing screen B. In response to a capturing of the photographic subject by the CMOS sensor 405 (an example of the imaging device or the camera), the display control unit 101 displays on the display 418 a page confirmation screen C that includes the result of the predetermined image processing for the photographic subject.

In response to receiving an instruction indicating the completion of capturing on the page confirmation screen C, or in response to receiving an instruction indicating the completion of imaging on the boundary manual correction screen D that allows manual correction of the boundary of the trapezoid included in the captured result of the photographic subject, the display control unit 101 causes the display 418 to display an application screen E which receives an instruction to transmit the captured result of the photographic subject to the server 2. A storage destination such as an e-mail address, the server 2, or a folder registered in the server 2, of the image data that is the captured result of the photographic subject, is possible to be set on the application screen E. Information regarding the transmission destination and the storage destination is an example of setting information. The setting information included in the application screen E is not limited to this example. The image processing execution unit 104 transmits the captured result of the photographic subject to the server 2 according to the instruction on the application screen E. The image processing execution unit 104 transmits to the server 2 an image (the captured result of the photographic subject) on which predetermined image processing has been performed.

The display control unit 101 displays the application screen A or the page confirmation screen C that includes operation items for receiving editing operations (for example, the above-mentioned procedure correction) for the results of the predetermined image processing from the user (operator) of the terminal device 1. Then, in response to receiving operation of the operation item, the display control unit 101 may display the boundary manual correction screen D, which is an example of a screen for editing operation, on the same screen as the page confirmation screen C, which is an example of a screen displaying the result of predetermined image processing, or on a different screen.

However, in a case where the activation of the CMOS sensor 405 fails even though the CMOS sensor 405 is activated in accordance with the instruction to capture the photographic subject on the document capturing screen B, the display control unit 101 causes the display 418 to display a camera activation error dialog F for instructing acquisition of the capture result of the photographic subject by upgrading the web browser or by other method. In response to an instruction to upgrade the web browser, the display control unit 101 displays the document capturing screen B on the display 418 again after upgrading the web browser.

On the other hand, in response to an instruction to acquire the captured result of the photographic subject by other method, the display control unit 101 causes the display 418 to display an operating system (OS) dependent screen G that allows an instruction of the acquisition of the captured result of the photographic subject. On the OS dependent screen G, a desired image is selectable from image data stored in the terminal device 1 or an external device that communicates with the terminal device 1. Furthermore, on the OS dependent screen G, the user may obtain the captured result of the photographic subject by starting a camera application or the like and perform capturing. Thereafter, the display control unit 101 causes the display 418 to display the page confirmation screen C including the acquired captured result of the photographic subject.

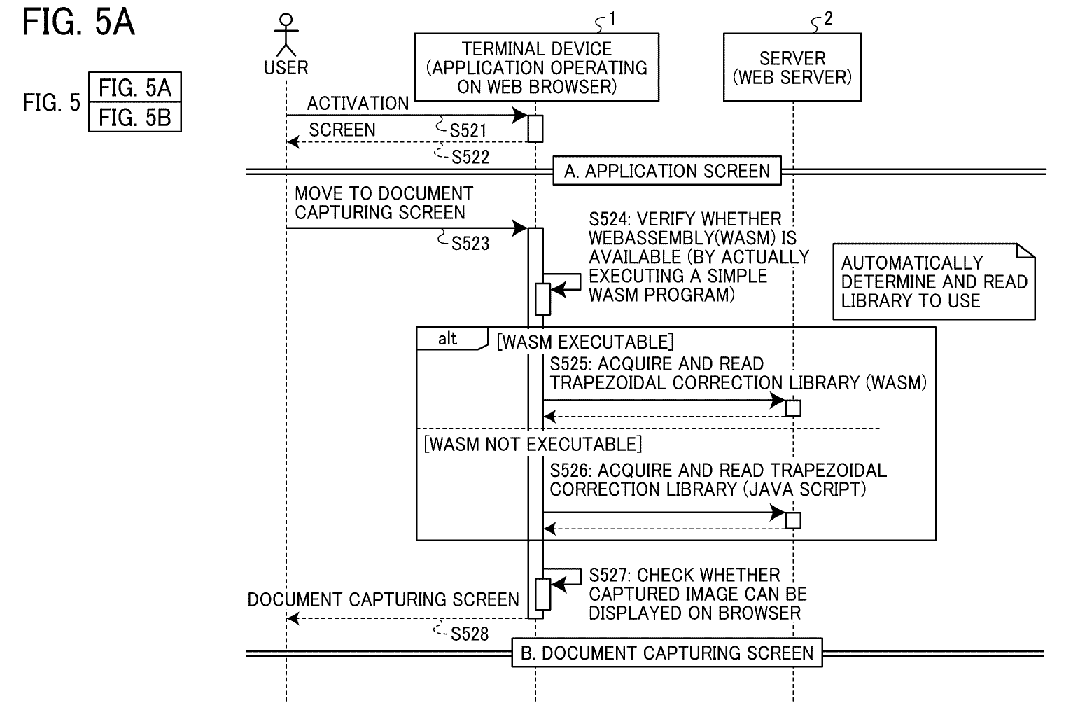

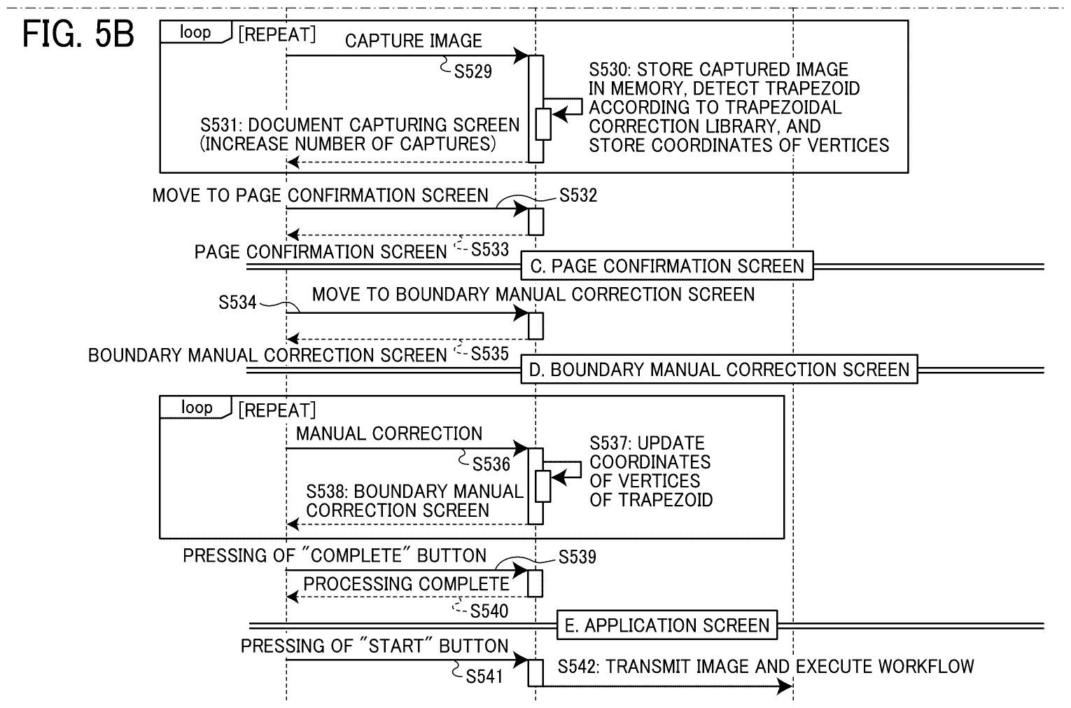

FIGS. 5A and 5B are a sequence diagram illustrating an example of the predetermined image processing executed by the information processing system according to embodiments of the present disclosure. In the case where the terminal device 1 includes a plurality of web browsers, the following processing is executed for each web browser. The following processing is executed by the web browser that the user has instructed to start, out of the plurality of web browsers. In response to an instruction to activate an application that operates on the web browser of the terminal device 1 in step S521, the display control unit 101 causes the display 418 to display the application screen A that receives various operations in step S522.

In response to an instruction on the application screen A to move to the document capturing screen B where the CMOS sensor 405 is instructed to capture in step S523, the verification unit 102 uses the verification information to perform the verification process to determine whether the terminal device 1 is capable of performing the predetermined image processing in step S524. In the present embodiment, the verification unit 102 verifies whether WASM is executable. For example, the verification unit 102 verifies whether WASM is executable based on whether a simple WASM program, which is an example of verification information, is executable.

Based on a verification result that WASM is executable, the library acquisition control unit 103 acquires and reads the first image processing library (for example, a trapezoidal correction library written in WASM) from the server 2 in step S525. Based on a verification result that WASM is not executable, the library acquisition control unit 103 acquires and reads the second image processing library (for example, a trapezoidal correction library written in JS) from the server 2 in step S526. In step S527, the verification unit 102 determines whether the use of the CMOS sensor 405 is permitted. In the present embodiment, the verification unit 102 determines whether use of the CMOS sensor 405 is permitted by whether the video (image) captured by the CMOS sensor 405 is displayed in the web browser.

Based on determination that the use of the CMOS sensor 405 is permitted, the display control unit 101 displays the document capturing screen B on the display 418 in step S528. The image processing execution unit 104 stores the captured image in a memory such as the RAM 403 each time the CMOS sensor 405 captures an image in step S529, and performs the predetermined image processing (for example, a process of detecting a trapezoid included in the image and retaining apex coordinates) on the image in step S530 according to the first image processing library (for example, the trapezoidal correction library). In this example, the image processing execution unit 104 generates an image by performing trapezoidal correction on the captured image and hold the generated image in a memory such as the RAM 403. In another example, the image processing execution unit 104 retains setting information for the trapezoidal correction and generates an image that has been subjected to the trapezoidal correction in response to receiving an instruction to transition to the page confirmation screen C, or in response to receiving a pressing of the start button on the application screen E. In step S531, the display control unit 101 displays the document capturing screen B on the display 418 again.

In response to receiving an instruction from the user to transition to the page confirmation screen C that includes the image captured by the CMOS sensor 405 in step S532, the display control unit 101 causes the display 418 to display the page confirmation screen C that includes the image that has undergone predetermined image processing in step S533. In response to receiving an instruction from the user to transition to the boundary manual correction screen D that allows manual correction of the trapezoidal boundary included in the image captured by the CMOS sensor 405 in step S534, the display control unit 101 displays the boundary manual correction screen D on the display 418 in step S535.

Following the manual boundary correction of the trapezoid performed on the boundary manual correction screen D in step S536, the image processing execution unit 104 updates the coordinates of the vertices of the trapezoid included in the image in step S537. In step S538, the display control unit 101 causes the display 418 to display the boundary manual correction screen D including the trapezoid image with the updated coordinates of the updated vertices. In response to pressing of a complete button on the boundary manual correction screen D in step S539, the image processing execution unit 104 ends the predetermined image processing on the image in step S540.

In response to a pressing of the start button on the application screen E in step S541, the library acquisition control unit 103 transmits the image on which the predetermined image processing has been performed to the server 2 in step S542. At this time, the terminal device 1 transmits the setting information input on the application screen E to the server 2. As a result, the server 2 executes the workflow based on the image that has undergone the predetermined image processing and the setting information. Since the server 2 is capable of executing a plurality of workflows, for example, the terminal device 1 transmits information specifying a workflow to the server 2. In this example, the workflow to execute is set on the application screen. For example, on the application screen A, a workflow to be linked is selectable. In another example, by inputting a uniform resource locator (URL) into the web browser, a workflow corresponding to the URL is linked.

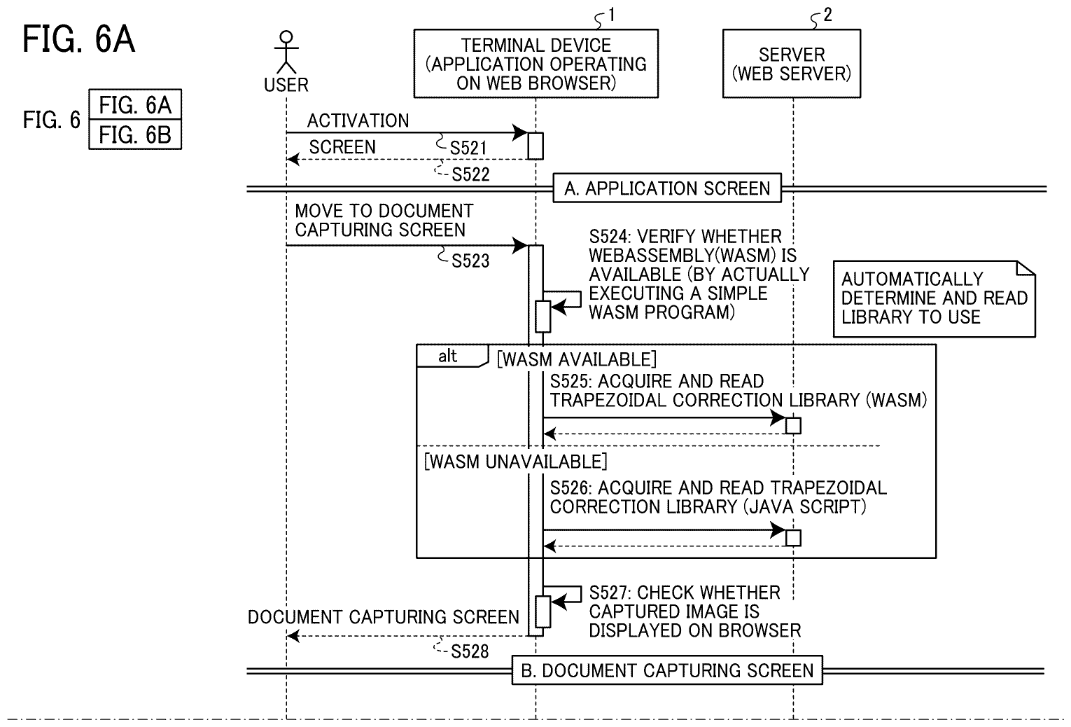

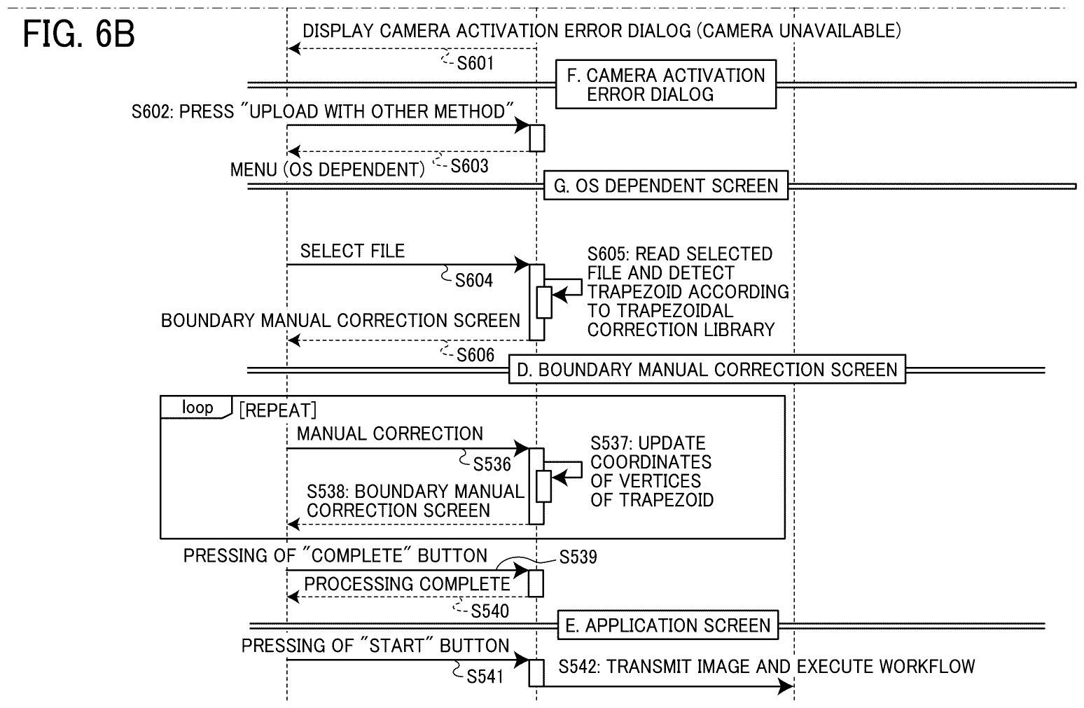

FIGS. 6A and 6B are a sequence diagram illustrating another example of the predetermined image processing executed by the information processing system according to embodiments of the present disclosure. In FIGS. 6A and 6B, description of processes similar to those in FIGS. 5A and 5B are omitted.

Based on determination in step S527 that the use of the CMOS sensor 405 is not permitted, the display control unit 101 causes the display 418 to display the document capturing screen B again in step S528. In step S601, the display control unit 101 causes the display 418 to display the camera activation error dialog F that notifies of an error occurred in activation of the CMOS sensor 405.

In response to receiving an instruction to capture an image by other method on the camera activation error dialog F in step S602, the display control unit 101 causes the display 418 to display the OS dependent screen G including a menu from which an image capturing method is to be selected in step S603. In response to receiving a selection of an image file on the OS dependent screen G in step S604, the image processing execution unit 104 executes the predetermined image processing on the selected image using the read image processing library from among the first image processing library and the second image processing library in step S605. In step S606, the display control unit 101 causes the display 418 to display the boundary manual correction screen D including the image subjected to the predetermined image processing.

In response to receiving a pressing of a completion button on the boundary manual correction screen D in step S539, the image processing execution unit 104 ends the predetermined image processing on the image in step S540.

As described above, according to the information processing system of the present embodiment, data processing functions in browser-based applications are enabled by performing the predetermined image processing on the photographic subject by using the image processing library executable on the web browser.

The apparatuses or devices described in one or more embodiments are examples of plural computing environments that implement the one or more embodiments disclosed herein. In one embodiment, server 2 includes multiple computing devices, such as a server cluster. The multiple computing devices are configured to communicate with one another through any type of communication link, including a network, shared memory, and the like, and perform the processes disclosed herein. Similarly, the terminal device 1 may include multiple computing devices configured to communicate with one another.

For example, the terminal device 1 and the server 2 are configured to share the disclosed processing steps, for example, in FIG. 1, in various combinations. For example, a process executed by the terminal device 1 may be executed by the server 2. In another example, the functions of the server 2 are performed by the terminal device 1. Moreover, each element of the terminal device 1 and the server 2 may be combined into one server, or may be divided into a plurality of devices.

Note that the terminal device 1 or the server 2 is not limited to a smartphone or a server as long as the devices include a communication function. The terminal device 1 or the server 2 is, for example, an output device such as a projector (PJ), an interactive white board ((IWB) a white board having an electronic whiteboard function capable of mutual communication), a digital signage, a head up display (HUD) device, an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

Note that the programs executed by the terminal device 1 and the server 2 of the present embodiment are preinstalled in the ROMs 402, 502 and the like and provided. The program executed by the terminal device 1 or server 2 according to the present embodiment may be stored in a computer readable storage medium, such as a compact disc read only memory (CD-ROM), a flexible disk (FD), a compact disc recordable (CD-R), and a digital versatile disc (DVD), in an installable or executable file format for distribution.

Furthermore, the program executed by the terminal device 1 or server 2 according to the present embodiment may be stored in a computer connected to a network such as the internet and downloaded through the network. Further, the programs executed by the terminal device 1 and the server 2 of the present embodiment may be provided or distributed through a network such as the internet.

The program executed by the terminal device 1 of the present embodiment has a module configuration including each unit described above (the display control unit 101, the verification unit 102, the library acquisition control unit 103, the image processing execution unit 104). In actual hardware, a processor such as the CPU 401 reads and executes a program from the ROM 402, so that each of the above units is loaded onto the main storage device and the display control unit 101, the verification unit 102, the library acquisition control unit 103, and the image processing execution unit 104 are generated on the main storage device.

The program executed by the server 2 of the present embodiment has a module configuration including each unit described above (the reception unit 201 and the transmission unit 202). In actual hardware, a processor such as the CPU 501 reads and executes a program from the ROM 502, so that each of the above units is loaded onto the main storage device, and the reception unit 201 and transmission unit 202 are generated on the main storage device.

Aspects of the present disclosure are, for example, as follows.

According to a first aspect, a terminal device for performing predetermined image processing through a browser includes a verification unit to perform a verification process to determine whether the browser is capable of performing the predetermined image processing, using verification information for verifying whether the browser is capable of performing the predetermined image processing on a photographic subject based on a capturing operation on the photographic subject, an acquisition control unit to acquire a first image processing library written in a first programming language to perform the predetermined image processing based on determination that the browser is capable of performing the predetermined image processing as a result of the verification process and to acquire a second image processing library written in a second programming language to perform the predetermined image processing based on determination that the browser is incapable of performing the predetermined image processing, an image processing unit to perform the predetermined image processing using at least one of the first image processing library or the second image processing library, and a display control unit to display a result of the predetermined image processing performed based on at least one of the first image processing library or the second image processing library on a screen of the terminal device.

According to a second aspect, in the terminal device of the first aspect, the first programming language is the same programming language as the verification information, and the second programming language is a different programming language from the verification information.

According to a third aspect, in the terminal device of the first aspect or the second aspect, the acquisition control unit acquires the first image processing library and the second image processing library from a server that stores the first image processing library and the second image processing library.

According to a fourth aspect, in the terminal device of any one of the first aspect to the third aspect, at least one of the first image processing library or the second image processing library includes a library of the image processing unit that stores the photographic subject in a rectangle expressed by a predetermined frame line displayed on the screen of the terminal device.

According to a fifth aspect, in the terminal device of the second aspect, the programming language to write the first image processing library is WASM and the programming language to write the second image processing library is JS.

According to a sixth aspect, in the terminal device of any one of the first aspect to the fifth aspect, the display control unit further displays on the display a screen including an operation item to receive an editing operation on the result of the predetermined image processing from an operator of the terminal device, and in response to receiving an operation on the operation item, displays on the display the editing operation screen on at least one of the same screen as the screen displaying the results of the predetermined image processing or a separate screen.

According to a seventh aspect, in the terminal device of any one of the first aspect to the sixth aspect, the verification process is performed in a case permission is given to use a camera that performs the capturing.

According to an eighth aspect, in any one of the first aspect to the seventh aspect, the terminal device further includes a transmission unit to transmit the result of the predetermined image processing to a server.

According to a ninth aspect, an information processing method executed by a terminal device for performing predetermined image processing through a browser includes, a verification step for performing a verification process to determine whether the browser is capable of performing the predetermined image processing, using verification information for verifying whether the browser is capable of performing the predetermined image processing on a photographic subject based on a capturing operation on the photographic subject, an acquisition step for acquiring a first image processing library written in a first programming language to perform the predetermined image processing based on determination that the browser is capable of performing the predetermined image processing as a result of the verification process and for acquiring a second image processing library written in a second programming language to perform the predetermined image processing based on determination that the browser is incapable of performing the predetermined image processing, an image processing step for performing the predetermined image processing using at least one of the first image processing library or the second image processing library, and a display control step to display a result of the predetermined image processing performed based on at least one of the first image processing library or the second image processing library on a screen of the terminal device.

According to a tenth aspect, a program to cause a general computer to perform predetermined image processing through a browser to function as a verification unit to perform a verification process to determine whether the browser is capable of performing the predetermined image processing, using verification information for verifying whether the browser is capable of performing the predetermined image processing on a photographic subject based on a capturing operation on the photographic subject, an acquisition control unit to acquire a first image processing library written in a first programming language to perform the predetermined image processing based on determination that the browser is capable of performing the predetermined image processing as a result of the verification process and to acquire a second image processing library written in a second programming language to perform the predetermined image processing based on determination that the browser is incapable of performing the predetermined image processing, an image processing unit to perform the predetermined image processing using the first image processing library or the second image processing library, and a display control unit to display a result of the predetermined image processing performed based on the first image processing library or the second image processing library on a screen of a terminal device.

According to an eleventh aspect, an information processing system for performing predetermined image processing through a browser includes, a verification unit to perform a verification process to determine whether the browser is capable of performing the predetermined image processing, using verification information for verifying whether the browser is capable of performing the predetermined image processing on a photographic subject based on a capturing operation on the photographic subject, an acquisition control unit to acquire a first image processing library written in a first programming language to perform the predetermined image processing based on determination that the browser is capable of performing the predetermined image processing as a result of the verification process and to acquire a second image processing library written in a second programming language to perform the predetermined image processing based on determination that the browser is incapable of performing the predetermined image processing, an image processing unit to perform the predetermined image processing using the first image processing library or the second image processing library, and a display control unit to display a result of the predetermined image processing performed based on the first image processing library or the second image processing library on a screen of a terminal device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A terminal device comprising circuitry configured to:
verify whether a browser of the terminal device is capable of performing predetermined image processing, using verification information on a photographic subject based on a capturing operation on the photographic subject,
wherein, based on a determination that the browser is capable of performing the predetermined image processing as a result of the verification,
the circuitry is configured to acquire a first image processing library written in a first programming language to perform the predetermined image processing using the first image processing library, and display a result of the predetermined image processing performed based on the first image processing library on a screen of the terminal device, and
wherein, based on a determination that the browser is incapable of performing the predetermined image processing as a result of the verification,
the circuitry is configured to acquire a second image processing library written in a second programming language to perform the predetermined image processing using the second image processing library, and display a result of the predetermined image processing performed based on the second image processing library on the screen of the terminal device.

2. The terminal device of claim 1, wherein
the first programming language is the same programming language as that of the verification information, and
the second programming language is a different programming language from that of the verification information.

3. The terminal device of claim 1, wherein
the circuitry is configured to acquire the first image processing library and the second image processing library from a server that stores the first image processing library and the second image processing library.

4. The terminal device of claim 1, wherein
at least one of the first image processing library or the second image processing library includes a library for correcting the photographic subject so as to fit the photographic subject in a rectangle expressed by a predetermined frame line displayed on the screen of the terminal device.

5. The terminal device of claim 2, wherein
the first image processing library is written in WebAssembly, and the second image processing library is written in Java Script.

6. The terminal device of claim 1, wherein
the circuitry is further configured to:
display on a display another screen including an operation item to receive an editing operation on the result of the predetermined image processing from an operator of the terminal device; and
in response to receiving the operation of the operation item, display on the display an editing operation screen on the same screen as the screen displaying the result of the predetermined image processing or a different screen from the screen displaying the result of the predetermined image processing.

7. The terminal device of claim 1, wherein
the circuitry is configured to perform verification in a case a permission is given to use a camera that performs the capturing operation.

8. The terminal device of claim 1, wherein
the circuitry is further configured to transmit the result of the predetermined image processing to a server.

9. An information processing method executed by a terminal device, comprising:
verifying whether a browser of the terminal device is capable of performing a predetermined image processing using verification information on a photographic subject based on a capturing operation on the photographic subject;
wherein, based on a determination that the browser is capable of performing the predetermined image processing as a result of the verification, the method further comprising:
acquiring a first image processing library written in a first programming language to perform the predetermined image processing;
performing the predetermined image processing using the first image processing library; and
displaying a result of the predetermined image processing performed based on the first image processing library on a screen of the terminal device, and
wherein, based on a determination that the browser is incapable of performing the predetermined image processing as a result of the verification, the method further comprising:
acquiring a second image processing library written in a second programming language to perform the predetermined image processing;
performing the predetermined image processing using the second image processing library; and
displaying a result of the predetermined image processing performed based on the second image processing library on the screen of the terminal device.

10. A non-transitory recording medium storing a plurality of instructions which, when executed by one or more processors on a terminal device, causes the processors to perform an information processing method, the method comprising:
verifying whether a browser of the terminal device is capable of performing a predetermined image processing using verification information on a photographic subject based on a capturing operation on the photographic subject;
wherein, based on a determination that the browser is capable of performing the predetermined image processing as a result of the verification, the method further comprising:
acquiring a first image processing library written in a first programming language to perform the predetermined image processing;
performing the predetermined image processing using the first image processing library; and
displaying a result of the predetermined image processing performed based on the first image processing library on a screen of the terminal device, and
wherein, based on a determination that the browser is incapable of performing the predetermined image processing as a result of the verification, the method further comprising:
acquiring a second image processing library written in a second programming language to perform the predetermined image processing;
performing the predetermined image processing using the second image processing library; and
displaying a result of the predetermined image processing performed based on the second image processing library on the screen of the terminal device.
